(19) United States
(12) Patent Application Publication
(10) Pub. No.: US 2026/0124780 A1
(43) Pub. Date: May 7, 2026

(54) SECONDARY BATTERY ELECTRODE PLATE CUTTING DEVICE, SECONDARY BATTERY MANUFACTURING DEVICE INCLUDING SAME, AND SECONDARY BATTERY MANUFACTURING METHOD

(71) Applicant: Samsung SDI Co., Ltd., Yongin-si (KR)

(72) Inventors: Junhwan Kwon, Yongin-si (KR); Jinhwan Kim, Yongin-si (KR); Jongmin Im, Yongin-si (KR); Bonggeun Kang, Yongin-si (KR)

(73) Assignee: Samsung SDI Co., Ltd., Yongin-si (KR)

(21) Appl. No.: 19/253,648

(22) Filed: Jun. 27, 2025

(30) Foreign Application Priority Data
Nov. 6, 2024 (KR) 10-2024-0156595

(51) Int. Cl. B26F 1/14; B65H 18/10

(52) U.S. Cl. CPC B26F 1/14; B65H 18/10; B65H 2301/4143; B65H 2301/515; B65H 2301/516; B65H 2701/19

(57) ABSTRACT

The present disclosure relates to a secondary battery electrode plate cutting device, a secondary battery manufacturing device including the same, and a secondary battery manufacturing method. The secondary battery electrode plate cutting device includes a cutting unit provided with an upper cutter and a lower cutter installed on opposite sides with an electrode plate, which moves along a transfer path therebetween and configured to cut the electrode plate, a cover film supply part configured to supply a cover film to be laminated on a surface of the electrode plate, and a laminating part configured to laminate with the cover film the electrode plate before cutting so that the cutting unit cuts the cover film together with the electrode plate.

### CROSS-REFERENCE TO RELATED APPLICATIONS

This application claims priority to and the benefit of Korean Patent Application No. 10-2024-0156595, filed on Nov. 6, 2024, the disclosure of which is incorporated herein by reference in its entirety.

### FIELD

The present disclosure relates to a secondary battery electrode plate cutting device, a secondary battery manufacturing device including the same, and a secondary battery manufacturing method, which reduce deformation of a shear surface of an electrode plate when the electrode plate for a secondary battery is cut.

### BACKGROUND

Different from primary batteries that cannot be charged, secondary batteries can be charged and discharged. Typically, a secondary battery includes an electrode assembly formed of positive and negative electrode plates and a separator. The electrode plate may be manufactured through coating, rolling, slitting, and notching processes.

An electrode plate cutter may be used in the manufacturing process of the electrode plate. The electrode plate cutter includes an upper cutter and a lower cutter installed above and below the electrode plate transferred along a transfer path. The upper cutter and the lower cutter cut the electrode plate positioned therebetween through cross motion.

The herein information disclosed in this Background section is for enhancement of understanding of the background of the present disclosure, and therefore, it may contain information that does not constitute a related (or prior) art.

### SUMMARY

The present disclosure is directed to providing a secondary battery electrode plate cutting device, a secondary battery manufacturing device including the same, and a secondary battery manufacturing method, which hardly cause deformation of a shear surface and do not cause deintercalation of an active material from a substrate because a load applied on an electrode plate by a cutter is distributed.

According to an aspect of the present disclosure, there is provided a secondary battery electrode plate cutting device including a cutting unit provided with an upper cutter and a lower cutter installed on opposite sides with an electrode plate, which moves along a transfer path, therebetween and configured to cut the electrode plate, a cover film supply part configured to supply a cover film to be laminated on a surface of the electrode plate, and a laminating part configured to laminate with the cover film the electrode plate before cutting so that the cutting unit cuts the cover film together with the electrode plate.

According to another aspect of the present disclosure, there is provided a secondary battery manufacturing device including an electrode plate transfer part configured to transfer an electrode plate along a transfer path, a cutting unit provided with an upper cutter and a lower cutter installed on opposite sides with the electrode plate therebetween and configured to cut the electrode plate, a cover film supply part configured to supply a cover film to be laminated on a surface of the electrode plate, a laminating part configured to laminate with the cover film the electrode plate before cutting so that the cutting unit cuts the cover film together with the electrode plate, and a film separator configured to separate the cover film from the electrode plate passing through the cutting unit.

According to still another aspect of the present disclosure, there is provided a secondary battery manufacturing method including a transfer operation of moving an electrode plate to be cut along a transfer path, a cover film supply operation of supplying a cover film to be laminated on a surface of the electrode plate, a lamination operation of laminating with the supplied cover film the electrode plate, a cutting operation of cutting the electrode plate to which the cover film is laminated, a delamination operation of removing the cover film from a cut film stack; and a winding operation of winding the electrode plate from which the cover film is removed.

Aspects and features of the present disclosure are not limited to those described herein, and other aspects and features not specifically mentioned herein will be clearly understood by those skilled in the art from the description of the present disclosure herein.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a schematic diagram illustrating an electrode assembly of a secondary battery manufactured using an electrode plate cutting device according to some embodiments of the present disclosure;

FIG. 2 is a diagram illustrating an interior of a pouch-type battery to which the electrode assembly of FIG. 1 is applied;

FIG. 3 is a cross-sectional view illustrating a cylindrical battery manufactured through a secondary battery manufacturing device according to some embodiments of the present disclosure;

FIG. 4 is a perspective view illustrating an exterior of a prismatic battery manufactured through the secondary battery manufacturing device according to some embodiments of the present disclosure;

FIG. 5 is a cross-sectional view along line A-A of FIG. 4;

FIGS. 6 to 8 are diagrams for describing a configuration and an operation of the secondary battery manufacturing device provided with the electrode plate cutting device according to some embodiments of the present disclosure;

FIG. 9 is a partial cross-sectional view for describing a configuration of a roller assembly included in a film pusher of FIG. 6;

FIG. 10 is a side view for describing an operational effect of the film pusher shown in FIG. 6;

FIGS. 11 and 12 are diagrams illustrating an operation of the film pusher applied to the electrode plate cutting device according to some embodiments of the present disclosure;

FIG. 13 is a diagram illustrating another example of the film pusher of FIG. 6;

FIGS. 14 and 15 are diagrams for describing a configuration and operation of a film separator of FIG. 6; and

FIG. 16 is a flowchart illustrating a secondary battery manufacturing method according to some embodiments of the present disclosure.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way. The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

The conventional electrode plate cutting device has a problem in that, when the electrode plate is cut, since the upper cutter and the lower cutter come into direct contact with a laminated surface of the electrode plate to perform cutting, the upper and lower cutters generate compressive and tensile deformation of a shear surface with respect to the electrode plate. That is, plastic deformation and fracture occur in the shear surface, which degrades quality and causes deintercalation of an active material.

In order to solve the herein problem, a physical load concentrated on the electrode plate should be distributed. However, the conventional cutting device does not have a configuration that can distribute concentrated loads applied on the electrode plate by the upper cutter and the lower cutter.

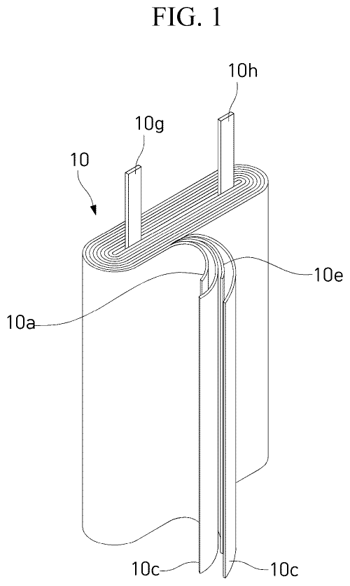

FIG. 1 is a schematic view illustrating an electrode assembly of a secondary battery which may be manufactured through an apparatus for manufacturing a secondary battery according to embodiments of the present disclosure.

An electrode assembly 10 may be formed by winding or stacking a first electrode plate 10a, a separator 10c, and a second electrode plate 10e, each of which are formed as thin plates or films.

In other embodiments, the electrode assembly 10 may be a stack type rather than a winding type, and the shape of the electrode assembly 10 is not limited in the present disclosure. In addition, the electrode assembly 10 may be a Z-stack electrode assembly in which a positive electrode plate and a negative electrode plate are inserted into both sides (e.g., opposite sides) of a separator, which is then bent (or folded) into a Z-stack

In addition, one or more electrode assemblies may be stacked (e.g., arranged) such that long sides of the electrode assemblies are adjacent to each other and accommodated in a case, and the number of electrode assemblies in a case is not limited in the present disclosure. The first electrode plate 10a of the electrode assembly 10 may act as a negative electrode, and the second electrode plate 10e may act as a positive electrode. Of course, the reverse is also possible.

The first electrode plate 10a may be formed by applying (e.g., coating or depositing) a first electrode active material, such as graphite or carbon, onto a first electrode substrate formed of a metal foil, such as copper, a copper alloy, nickel, or a nickel alloy. The first electrode plate 10a may include a first electrode tab 10g (e.g., a first uncoated portion), which is a region to which the first electrode active material is not applied. The first electrode tab 10g may be connected to an external first terminal. In some embodiments, when the first electrode plate 10a is manufactured, the first electrode tab 10g may be formed by being cut in advance to protrude to (or protrude from) one side of the electrode assembly 10, or the first electrode tab 10g may protrude to one side of the electrode assembly 10 more than (e.g., farther than or beyond) the separator 10c without being separately cut.

The second electrode plate 10e may be formed by applying (e.g., coating or depositing) a second electrode active material, such as a transition metal oxide, onto a second electrode substrate formed of a metal foil, such as aluminum or an aluminum alloy. The second electrode plate 10e may include a second electrode tab 10h (e.g., a second uncoated portion), which is a region to which the second electrode active material is not applied. The second electrode tab 10h may be connected to an external second terminal. In some embodiments, the second electrode tab 10h may be formed by being cut in advance to protrude to the other side (e.g., the opposite side) of the electrode assembly 10 when the second electrode tab 10h is manufactured, or the second electrode plate 10e may protrude to the other side of the electrode assembly 10 more than (e.g., farther than or beyond) the separator 10c without being separately cut.

The separator 10c prevents a short-circuit between the first electrode plate 10a and the second electrode plate 10e while allowing movement of lithium ions therebetween. The separator 10c may be made of, for example, a polyethylene film, a polypropylene film, a polyethylene-polypropylene film, or the like.

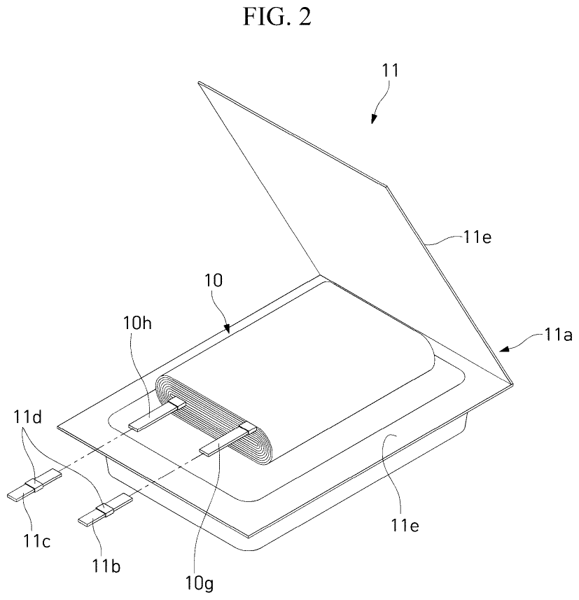

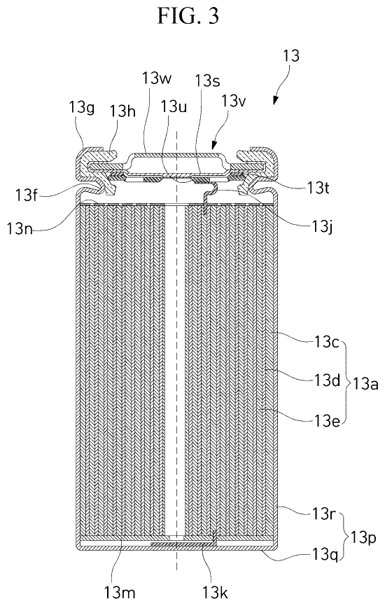

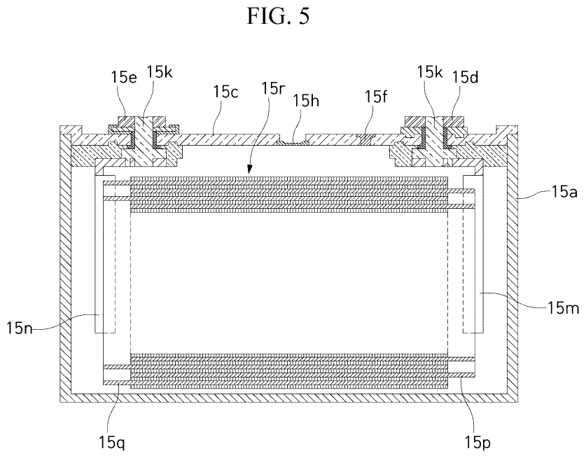

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIGS. 3 and 5).

A description is given of materials that can be used for the electrode plate of the herein electrode assembly.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃ (0≤f≤2); LiₐFePO₄ (0.90≤a≤1.8).

In the herein formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particles and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on one another.

FIG. 2 is a view illustrating an interior of a pouch-type battery to which the electrode assembly of FIG. 1 is applied.

The pouch-type secondary battery 11 includes an electrode assembly 10 and a pouch 11a that accommodates the electrode assembly 10.

The electrode assembly 10 is the same as that illustrated in FIG. 1. The first electrode tab 10g and the second electrode tab 10h of the electrode assembly 10 may be electrically connected to respective external first and second terminal leads 11b and 11c by welding. Each of the first terminal lead 11b and the second terminal lead 11c may be attached with a tab film 11d for insulation from the pouch 11a.

The pouch 11a may be sealed by having sealing parts 11e at the edges thereof come into contact with each other with accommodating the electrode assembly 10 therein, in which case the sealing may be achieved with the tab film 11d interposed between the sealing parts 11e. The sealing parts 11e of the pouch 11a may each be made of a thermal fusion material that generally has weak adhesion to metal. Thus, it may be fused to the pouch 11a by interposing the thin tab film 11d between the sealing parts 11e.

FIG. 3 is a cross-sectional view illustrating a cylindrical battery manufactured through the apparatus for manufacturing a secondary battery according to embodiments of the present disclosure.

The cylindrical battery 13 includes an electrode assembly 13a, a case 13p accommodating the electrode assembly 13a and an electrolyte therein, a cap assembly 13v coupled to an opening of the case 13p to seal the case 13p, and an insulating plate 13n positioned between the electrode assembly 13a and the cap assembly 13v inside the case 13p. The electrode assembly 13a may include a separator 13d and a first electrode 13c and a second electrode 13e positioned with the separator 13d interposed therebetween and may be wound in a jelly-roll shape.

The first electrode 13c includes a first substrate and a first active material layer on the first substrate. A first lead tab 13j may extend outwardly from a first uncoated portion of the first substrate at where the first active material layer is not located, and the first lead tab 13j may be electrically connected to the cap assembly 13v.

The second electrode 13e includes a second substrate and a second active material layer on the second substrate. A second lead tab 13k may extend outwardly from a second uncoated portion of the second substrate at where the second active material layer is not located, and the second lead tab 13k may be electrically connected to the case 13p. The first lead tab 13j and the second lead tab 13k may extend in opposite directions.

The first electrode 13c may act as a positive electrode. In such an embodiment, the first substrate may be made of, for example, an aluminum foil, and the first active material layer may include, for example, a transition metal oxide. The second electrode 13e may act as a negative electrode. In such an embodiment, the second substrate may be made of, for example, a copper foil or a nickel foil, and the second active material layer may include graphite, for example.

The separator 13d prevents a short circuit between the first electrode 13c and the second electrode 13e while allowing movement of lithium ions therebetween. The separator 13d may be made of, for example, a polyethylene film, a polypropylene film, a polyethylene-polypropylene film, or the like.

The case 13p accommodates the electrode assembly 13a and, together with the cap assembly 13v, forms the external appearance of the secondary battery. The case 13p may have a substantially cylindrical body portion 13r and a bottom portion 13q connected to one side (e.g., to one end) of the body portion 13r. A beading part 13f (e.g., a bead) deformed inwardly may be formed in the body portion 13r, and a crimping part 13g (e.g., a crimp) bent inwardly may be formed at an open end of the body portion 13r.

The beading part 13f can reduce or prevent movement of the electrode assembly 13a inside the case 13p and can facilitate seating of the gasket 13h and the cap assembly 13v. The crimping part 13g may firmly fix the cap assembly 13v by pressing the edge of the cap assembly 13v against the gasket 13h. The case 13p may be formed of steel plated with nickel, for example.

The cap assembly 13v may be fixed to the inside of the crimping part 13g by the gasket 13h to seal the case 13p. The cap assembly 13v may include a cap up 13w, a safety vent 13s, a cap down 13t, an insulating member, and a subplate 13u, but is not limited to these examples and may be modified in various ways.

The cap up 13w may be positioned at the uppermost part of the cap assembly 13v. The cap up 13w may include a terminal part that protrudes upwardly and is connected to an external circuit, and an outlet for discharging gas may be arranged around the terminal part.

The safety vent 13s may be located under the cap up 13w. The safety vent 13s may include a protrusion part that protrudes convexly downwardly and is connected to the sub plate 13u, and at least one notch may be formed in the safety vent 13s around the protrusion part.

When gas is generated due to overcharging or abnormal operation of the secondary battery, the protrusion part is deformed upwardly by the pressure and separates from the sub plate 13u while the safety vent 13s is cut (e.g., bursts or tears) along the notch. The cut safety vent 13s may prevent the secondary battery from exploding by allowing for the gas to be discharged to the outside.

The cap down 13t may be below the safety vent 13s. The cap down 13t may have a first opening for exposing the protrusion part of the safety vent 13s and a second opening for gas discharge. The insulating member may be positioned between the safety vent 13s and the cap down 13t to insulate the safety vent 13s and the cap down 13t.

The sub plate 13u may be under the cap down 13t. The sub plate 13u may be fixed to a lower surface of the cap down 13t to block the first opening of the cap down 13t, and the protrusion part of the safety vent 13s may be fixed to the sub plate 13u. The first lead tab 13j, which is drawn out from the electrode assembly 13a, may be fixed to the sub plate 13u. Accordingly, the cap up 13w, the safety vent 13s, the cap down 13t, and the sub plate 13u may be electrically connected to the first electrode 13c of the electrode assembly 13a.

The insulating plate 13n may be positioned to be in contact with the electrode assembly 13a below the beading part 13f. The insulating plate 13n may have a tab opening through which the first lead tab 13j is drawn out. The cap assembly 13v, which is electrically connected to the first electrode 13c by the first lead tab 13j, may face the electrode assembly 13a with the insulating plate 13n interposed therebetween and may maintain a state of being insulated (e.g., electrically insulated) from the electrode assembly 13a by the insulating plate. Meanwhile, another insulating plate 13m may be included for insulation between the electrode assembly 13a and the bottom portion 13q of the case 13p.

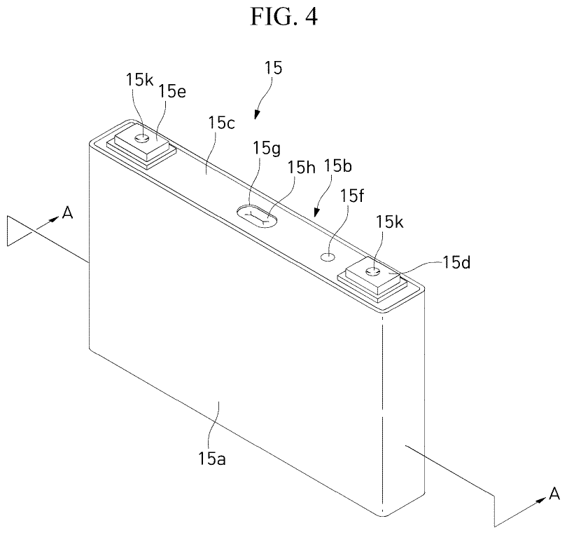

FIG. 4 is a perspective view illustrating an exterior of a prismatic battery which may be manufactured through the apparatus for manufacturing a secondary battery according to embodiments of the present disclosure.

A case 15a forms the overall appearance of a prismatic battery 15 and may be formed of a conductive metal such as aluminum, aluminum alloy, or nickel-plated steel. In addition, the case 15a may provide a space for accommodating an electrode assembly therein.

A cap assembly 15b may include a cap plate 15c that covers the opening of the case 15a. In some examples, the case 15a and the cap plate 15c may be made of a conductive material. Here, a first terminal 15d and a second terminal 15e may be electrically connected to respective positive and negative (or negative and positive) electrodes inside the case, and may be installed to protrude outward through the cap plate 15c.

An electrolyte inlet 15f may be formed in the cap plate 15c, a gas discharge hole 15g may be opened, and a vent, i.e., a gas discharge device 15h may be connected to the gas discharge hole 15g. The gas discharge device 15h is opened by gas generated inside the battery and performs a degassing function.

FIG. 5 is a cross-sectional view along line A-A in FIG. 4.

An electrode assembly 15r may be formed by winding or stacking a first electrode plate, a separator, and a second electrode plate. When the electrode assembly 15r is a wound type, a winding axis may be parallel to the longitudinal direction of the case 15a. In some other embodiments, the electrode assembly 15r is a stack type rather than a winding type. The shape of the electrode assembly 15r is not limited in the present disclosure.

In addition, the electrode assembly 15r may be a Z-stack electrode assembly in which a positive electrode plate and a negative electrode plate are inserted into both sides of a separator, which is then bent into a Z-stack. In addition, one or more electrode assemblies 15r may be stacked such that long sides of the electrode assemblies 15r are adjacent to each other and accommodated in the case 15a, and the number of electrode assemblies 15r in the case 15a is not limited in the present disclosure. The first electrode plate of the electrode assembly 15r may act as a negative electrode, and the second electrode plate may act as a positive electrode. Of course, the reverse is also possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 15p (e.g., a first uncoated portion) that is a region to which the first electrode active material is not applied. The first electrode tab 15p may act as a current flow path between the first electrode plate and the first current collector 15m. In some embodiments, when the first electrode plate is manufactured, the first electrode tab 15p is formed by being cut in advance to protrude to one side of the electrode assembly 15r, or the first electrode tab 15p protrudes to one side of the electrode assembly 15r more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 15q (e.g., a second uncoated portion) that is a region to which the second electrode active material is not applied. The second electrode tab 15q may act as a current flow path between the second electrode plate and the second current collector 15n. In some embodiments, the second electrode tab 15q may be formed by being cut in advance to protrude to the other side (e.g., the opposite side) of the electrode assembly 15r when the second electrode plate is manufactured, or the second electrode tab 15q may protrude to the other side of the electrode assembly 15r more than (e.g., farther than or beyond) the separator without being separately cut.

In FIG. 5, the first electrode tab 15p and the second electrode tab 15q are illustrated as being positioned on the right side and the left side of the electrode assembly 15r, respectively. However, in some other embodiments, both the first electrode tab 15p and the second electrode tab 15q may be positioned together on the right side or the left side of the electrode assembly 15r.

Here, the left side and the right side of the electrode assembly 15r are based on the battery illustrated in FIG. 5 for convenience of explanation. The left side refers to the side of the vertical surface of the electrode assembly 15r to which the second current collector 15n is joined, and the right side refers to the opposite side to which the first current collector 15m is joined. Therefore, the terms “left side” and “right side” of the electrode assembly 15r used herein may vary when the battery rotates left and right or up and down.

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

In some embodiments, an electrode assembly 15r is accommodated in the case 15a along with an electrolyte.

In the electrode assembly 15r, the first current collector 15m and the second current collector 15n may be welded and connected to the first electrode tab 15p extending from the first electrode plate and the second electrode tab 15q extending from the second electrode plate, respectively.

As illustrated in FIG. 5, the first current collector 15m and the second current collector 15n are connected to the first terminal 15d and the second terminal 15e through connection members 15k, respectively. In some embodiments, the connection members 15k may each have an outer peripheral surface that is threaded, and may be fastened to the first terminal 15d and the second terminal 15e by screwing. However, the present disclosure is not limited thereto. For example, the connection members 15k may also be coupled to the first terminal 15d and the second terminal 15e by riveting or welding.

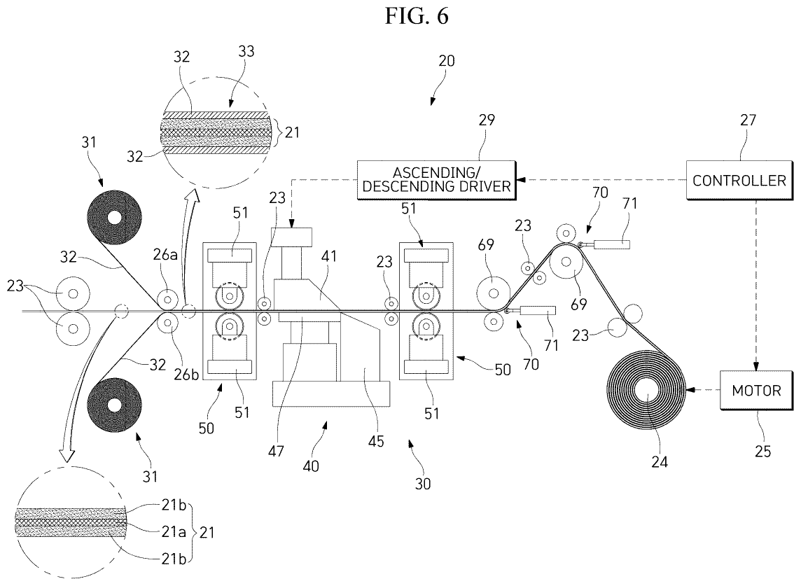

FIGS. 6 to 8 are diagrams for describing a configuration and an operation of a secondary battery manufacturing device 20 provided with the electrode plate cutting device 30 according to some embodiments of the present disclosure.

As shown in the drawings, the secondary battery manufacturing device 20 according to the present embodiment may include an electrode plate transfer part, an electrode plate cutting device 30, a film separator 70, a winding part, a controller 27, and an ascending/descending driver 29.

The electrode plate transfer part transfers an electrode plate 21, which is a cutting target, along a predetermined transfer path and may include a plurality of transfer rollers 23. Some of the transfer rollers are rollers having driving forces, the remaining transfer rollers do not have driving forces and may serve to support the transfer rollers tautly.

The electrode plate 21 is a stack made of a substrate 21a and a mixture material 21b. The mixture material 21b is an active material stacked on one or both sides of the substrate 21a.

In addition, the winding part may wind the electrode plate 21 transferred by the electrode plate transfer part. The winding part may include a winding roll 24 and a roll driving motor 25. The winding roll 24 may receive a rotation force from the roll driving motor 25, rotate, and wind the cut electrode plate 21. The electrode plate 21 wound on the winding roll 24 may be unloaded from the winding roll 24 by a worker and sent to a subsequent process.

In addition, the roll driving motor 25 may be operated by a control signal from the controller 27 to rotate or not rotate the winding roll 24. The controller 27 may control turning on/off and a rotation speed of the roll driving motor 25.

The ascending/descending driver 29 may serve to move up and down an upper cutter 41 which will be described herein. The ascending/descending driver 29 may be operated by a control signal from the controller 27.

Meanwhile, the electrode plate cutting device 30 may include a cutting unit 40, a cover film supply part 31, a laminating part, and two film pushers 50.

The cutting unit 40 serves to cut the electrode plate 21 transferred along the transfer path. The cutting unit 40 may include the upper cutter 41 and a lower cutter 45 installed to be opposite to each other with the electrode plate 21 interposed therebetween and configured to cut the electrode plate. The upper cutter 41 is positioned above the electrode plate 21, and the lower cutter 45 is positioned below the electrode plate.

The lower cutter 45 may cut the electrode plate 21 through cross motion with the upper cutter 41. An imaginary straight line connecting a blade of the upper cutter 41 and a blade of the lower cutter 45 may be orthogonal to the electrode plate 21. Here, the “cross motion” refers to a movement in which the blades of the upper cutter and lower cutter cross, like two blades of a scissor.

A stripper 47 may be provided on a side portion of the lower cutter 45. The stripper 47 may be elastically supported upward by a spring (not shown) to support the electrode plate 21.

The cover film supply part 31 may continuously supply a cover film 32 to be laminated on a surface of the electrode plate 21. A configuration of the cover film supply part may be implemented in various ways as long as the cover film 32 can be supplied. For example, after the winding cover film 32 is wound around the winding roll, the cover film 32 wound around the winding roll may be unwound and supplied.

The cover film 32 may distribute loads applied on the electrode plate 21 by the upper cutter 41 and the lower cutter 45 to serve to suppress deformation of the uppermost end portion of the shear surface of the electrode plate. That is, through a medium distributing the physical load applied on the electrode plate during the cutting, deintercalation of an active material constituting the electrode plate mixture material 21b is prevented during the cutting.

The cover film 32 may be made of a polymer material. The cover film 32 may have the same width as the electrode plate 21. In addition, flexibility of the cover film 32 may be different from that of the electrode plate 21. For example, the electrode plate 21 may have higher flexibility than the cover film 32 (e.g., the cover film 32 is stiffer than the electrode plate 21).

The cover film supply part 31 may supply the cover film 32 to at least one surface of both surfaces of the electrode plate. That is, the cover film supply part 31 may supply the cover film 32 only to a first surface of the electrode plate, only to a second surface, or to both the first and second surfaces. The first surface may be an upper surface facing the upper cutter 41, and the second surface may be a lower surface facing the lower cutter 45. FIGS. 6 to 8 show that the cover film 32 is supplied onto both the first and second surfaces.

The laminating part may serve to laminate with the cover film 32 the electrode plate 21 before the cutting. The electrode plate 21 laminated with cover film 32 may be transferred together and may be cut together with the electrode plate 21.

The laminating part may include a first laminating roller 26a and a second laminating roller 26b. The first laminating roller 26a may be disposed to correspond to the first surface of the electrode plate 21, and the second laminating roller 26b may be disposed to correspond to the second surface of the electrode plate 21. The laminating part may laminate with the cover film 32 at least one surface of the electrode plate 21, i.e., the first surface, the second surface, or both the first and second surfaces.

The film pusher 50 may elastically support the cover film 32 toward the electrode plate 21 while disposed at an upstream and a downstream of the cutting unit 40. The reason why the cover film 32 presses toward the electrode plate 21 is to stably maintain the cover film 32 in close contact with the electrode plate 21.

Each film pusher 50 may include a pair of roller assemblies 51. The roller assemblies 51 may be disposed to correspond to each other with the electrode plates 21 interposed therebetween. That is, one roller assembly 51 may be installed over the electrode plate 21, and the remaining roller assembly 51 may be installed below the electrode plate 21. The four roller assemblies 51 may have the same structure.

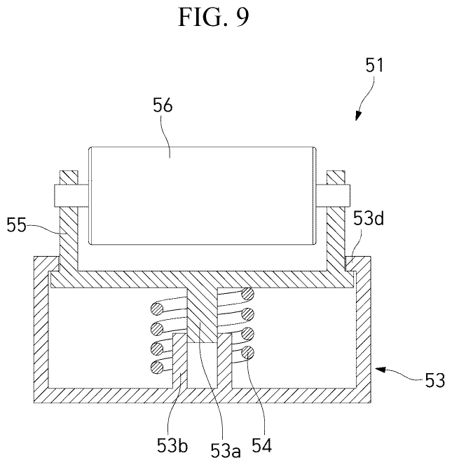

FIG. 9 is a partial cross-sectional view illustrating a basic configuration of the roller assembly 51.

As shown in the drawing, the roller assembly 51 may include a casing 53, an ascending/descending supporter 55, a spring 54, and a pusher roller 56.

The casing 53 may serve to support the ascending/descending supporter 55 to ascend and descend and include the spring 54 therein. A vertical guide 53b may be provided on a bottom portion of the casing 53. The vertical guide 53b serves to guide an ascending/descending movement of the ascending/descending supporter 55 to prevent a rotation axis of the pusher roller 56 from being inclined with respect to a horizontal plane.

In addition, a hook bump 53d is formed at an inner upper portion of the casing 53. The hook bump 53d may prevent the ascending/descending supporter 55 from being separated to the outside of the casing 53.

A portion of the ascending/descending supporter 55 may be accommodated in the casing 53 and axially rotatably support the pusher roller 56. A vertical extension 55a is formed on a bottom surface of a central portion of the ascending/descending supporter 55. The vertical extension 55a receives a supporting force from the vertical guide 53b. The vertical extension 55a may slide vertically while supported on the vertical guide 53b.

The spring 54 elastically supports the ascending/descending supporter 55 while mounted on a bottom of the casing 53. Due to the action of the spring 54, the pusher roller 56 may elastically press a film stack 33 in a direction of an arrow s. The film stack 33 is a stack in which the cover film 32 is laminated to the surface of the electrode plate 21.

The pusher roller 56 may be axially rotated while supported on the ascending/descending supporter 55. The pusher rollers 56 may elastically press the both surfaces of the electrode plate 21 being transferred to support the cover film 32 in close contact with the electrode plate 21. The pusher roller may be made of a steel or urethane.

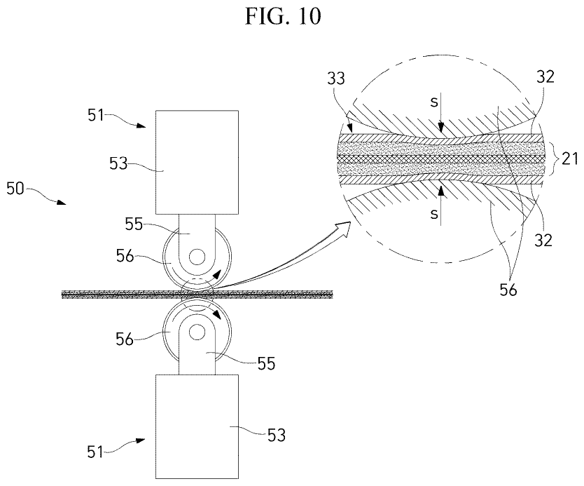

FIG. 10 is a schematic side view illustrating operation of the film pusher 50.

As shown in the drawing, the two roller assemblies 51 may be disposed to correspond to each other with the electrode plate 21 interposed therebetween. The pusher roller 56 elastically presses the film stack 33. The pusher roller 56 may be rotated due to friction with the film stack 33 when the film stack 33 is transferred. A spacing between the pusher rollers 56 may be adjusted using a spacing adjustment part which will be described herein.

Through the spacing adjustment part, the pusher rollers 56 may be spaced from the film stack 33. In addition, a pressing force of the pusher roller 56 with respect to the film stack 33 may be adjusted.

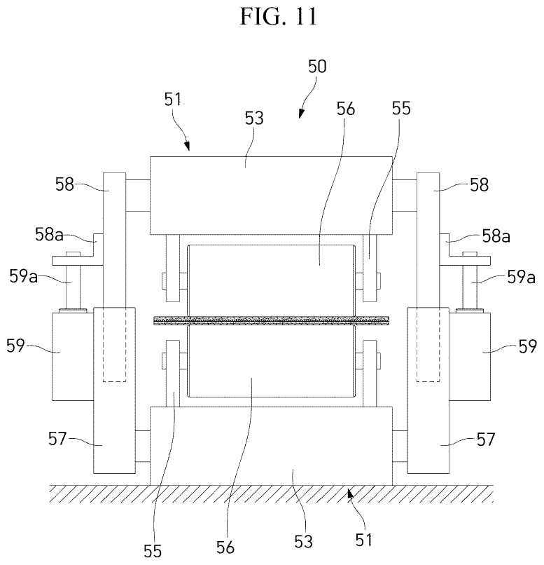

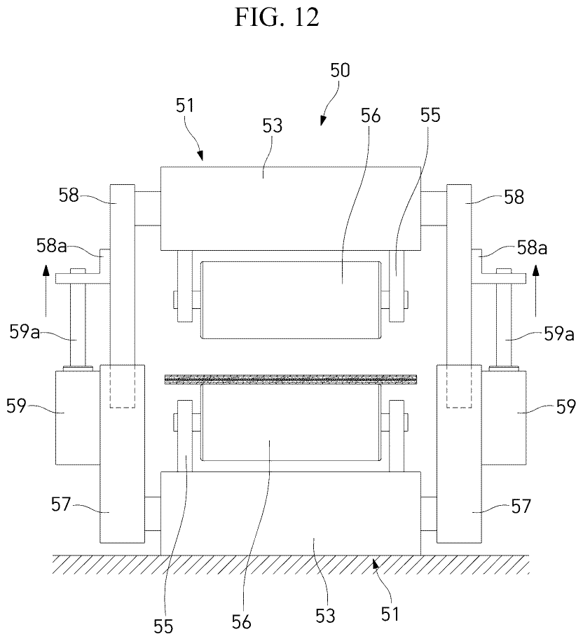

FIGS. 11 and 12 are diagrams illustrating an operation of the film pusher 50. FIG. 11 shows a state in which an upper roller assembly 51 descends, and FIG. 12 shows a state in which an upper roller assembly 51 ascends. The ascending/descending of the upper roller assembly 51 may be implemented by the spacing adjustment part.

The spacing adjustment part may adjust a spacing between the roller assemblies disposed to correspond to each other with the electrode plate 21 therebetween. The spacing adjustment part may include side guides 57, sliders 58, and actuators 59.

The side guides 57 are straight members fixed to both sides of the casing 53 of the lower roller assembly 51 in the drawing. The side guides 57 may be pipe-shaped members extending straight in a vertical direction.

The sliders 58 are straight members mounted vertically on both sides of the casing 53 of the upper roller assembly. The slider 58 extends vertically downward and forms a straight line with the side guide 57. The slider 58 performs a slide movement with respect to the side guide 57 by an operation of the actuator 59 while partially inserted into the side guide 57.

In addition, the actuators 59 may be installed on the two guides 57, and a fixing bracket 58a may be fixed to the slider 58. A piston rod 59a of the actuator 59 is connected to the fixing bracket 58a. Therefore, a height of the upper roller assembly 51 may be adjusted according to the operation of the actuator 59.

In addition, as shown in FIG. 11, while the upper and lower pusher rollers 56 are already in close contact with the film stack 33, when the upper roller assembly 51 is further moved down, a pressing force of the pusher roller 56 may increase against the film stack 33. The pressing force against the film stack 33 may be controlled using the actuator 59.

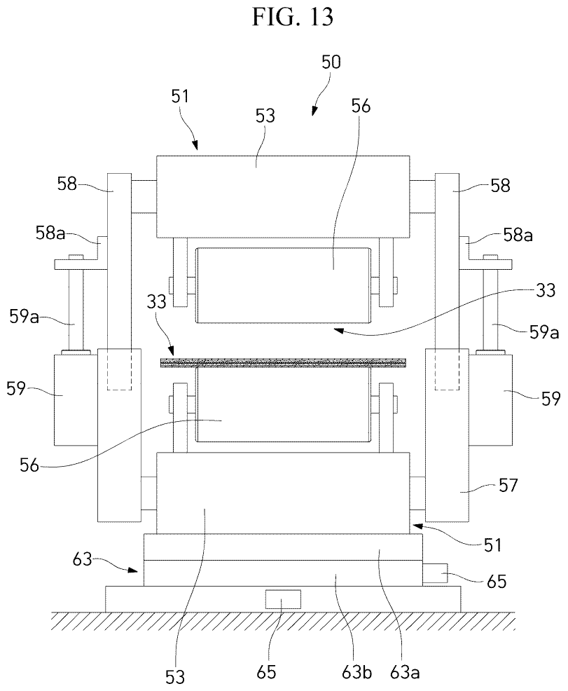

FIG. 13 is a diagram illustrating another example of the film pusher 50.

As shown in FIG. 13, an X-Y table 63 may be further applied below the film pusher 50 as a position adjustment part. While supporting the film pusher 50, the position adjustment part serves to adjustment a position of the film pusher 50 in an X direction which is a transfer direction of electrode plate and in a Y direction which is a width direction of the electrode plate.

The X-Y table 63 may be provided with a Y table 63b, an X table 63a, and a position adjustment motor 65. The Y table 63b is, for example, fixed parallel to the ground, a positioned of the Y table 63b may be adjusted by the position adjustment motor 65 in the Y direction. That is, the Y table 63b may be moved in the width direction of the electrode plate 21. In addition, the X-table 63a is slidably mounted on the Y-table 63b and a position of the X-table 63a may be adjusted by another position adjustment motor 65 in the X direction. By applying the position adjustment part, a position correction linked to an electronic product code (EPC) and additional improvement of a pressure distribution through diversification of a roller position are possible.

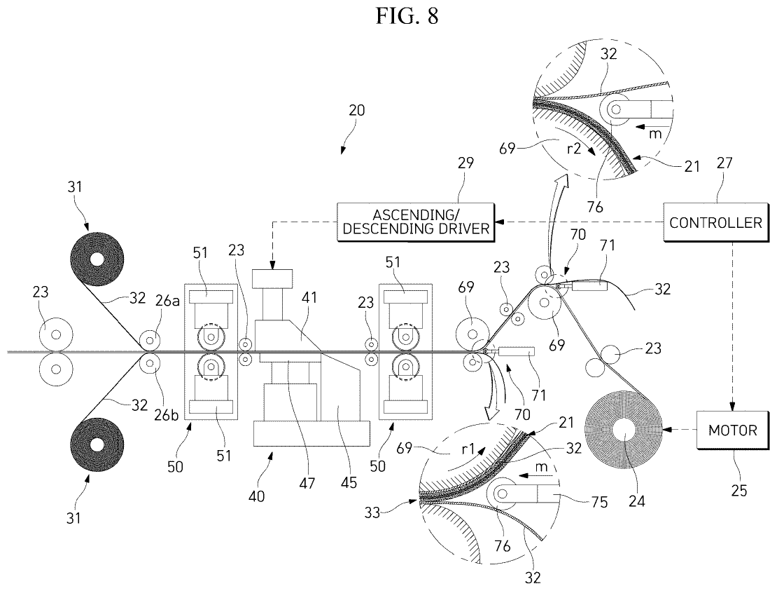

Meanwhile, the film separator 70 may serve to delaminate the cover film 32 from the electrode plate 21 passing through the cutting unit. That is, as shown in FIG. 8, the cover films 32 in surface contact with the second surface and the first surface of the electrode plate 21 are separated from the electrode plate 21.

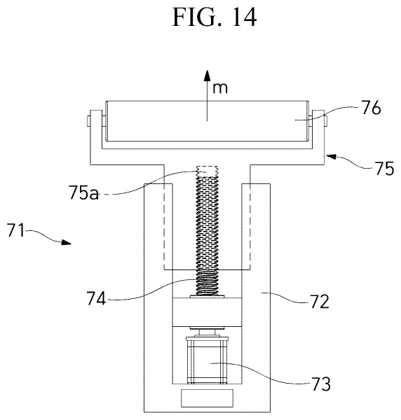

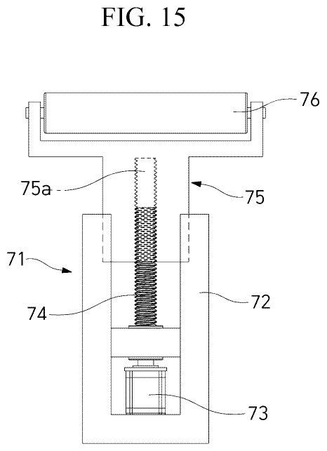

FIGS. 14 and 15 are diagrams for describing a configuration and operation of the film separator 70 of FIG. 6. In the present embodiment, two film separators 70 may be applied. One of the two film separators 70 is to delaminate the cover film 32 in close contact with the second surface, and the remaining one is to delaminate the cover film 32 in close contact with the first surface. The configurations and operating principles of the two film separators 70 are the same.

As shown in the drawings, the film separator 70 may include a delamination guide roll 60 and a separation module 71.

The delamination guide roll 60 may guide and bend the electrode plate 21 on which the cover films 32 are stacked to serve to lift an end portion of the cover film from the electrode plate due to a difference in bendability between the end portion and the electrode plate.

As shown in an enlarged view in FIG. 8, when the electrode plate 21 is bent upward while turning in a direction of an arrow r1 by a lower delamination guide roll 69, the cover film 32 is separated from the second surface of the electrode plate 21. As described herein, since the cover film 32 does not stickiness and is stiffer than the electrode plate 21, the cover film 32 is no longer in close contact with the electrode plate 21 and is separated from the electrode plate 21 due to its own physical properties.

Similarly, the cover film 32 in close contact with the first surface of the electrode plate 21 may be separated from the electrode plate 21 when the electrode plate 21 passes through an upper delamination guide roll 69 and is bent in a direction of an arrow r2.

The cover film 32 separated from the electrode plate 21 may be guided by the separation module 71 and completely separated from the electrode plate 21.

The separation module 71 may enter between the electrode plate 21 and the cover film 32 separated from the electrode plate 21 to perform delamination of the cover film 32.

FIGS. 14 and 15 show the separation module 71.

As shown in the drawings, the separation module 71 may include a guide body 72, a spacing adjustment motor 73, a lead screw 74, a roller holder 75, and a separation roller 76.

The guide body 72 is disposed to correspond to the transfer path of the electrode plate 21 and supports the spacing adjustment motor 73. The spacing adjustment motor 73 may axially rotate the lead screw 74 in both directions while fixed to the guide body 72.

In addition, the roller holder 75 may be slidably moved in a direction of an arrow m or an opposite direction while supported on the guide body 72. A female screw hole 75a is provided in the roller holder 75. The lead screw 74 is inserted into the female screw hole 75a. A reciprocating motion of the roller holder 75 may be performed due to the axial rotation of the lead screw 74.

In addition, the separation roller 76 is a circular-shaped rod member that is supported on a front end of the roller holder 75 to be axially rotatable. The separation roller 76 may be positioned between the electrode plate 21 and the cover film 32 to guide the delamination of the cover film 32.

FIG. 6 shows a state in which the electrode plate 21 and cover film 32 are supplied continuously. The cover films 32 supplied from the cover film supply parts 31 are moved toward the cutting unit 40 while in close contact with the electrode plate 21 by the first and second laminating rollers 26a and 26b.

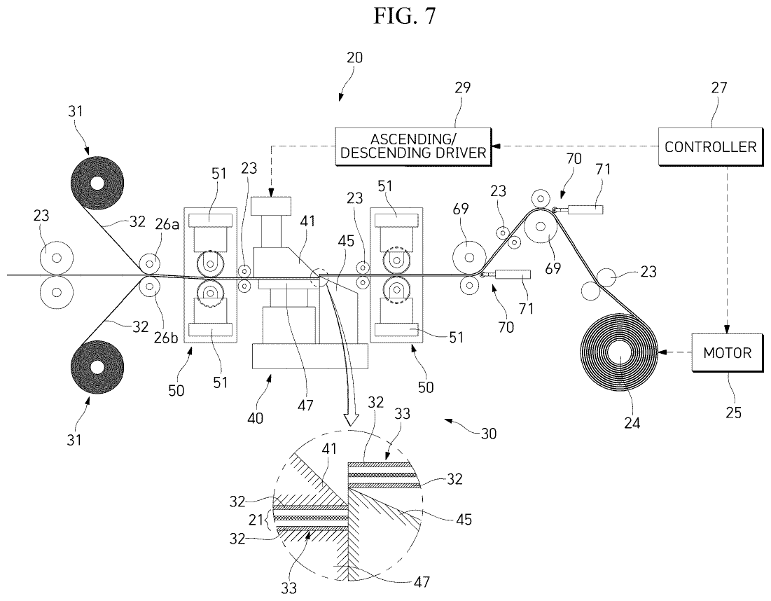

FIG. 7 shows a state in which the film stack 33 is cut as the upper cutter 41 descends. While the film stack 33 is cut, the film stack 33 is pressed by the film pushers 50 on both sides so that the cover film 32 may be formed integrally with the electrode plate 21. The cut film stack 33 between the upper cutter 41 and the stripper 47 is moved up due to an elastic force of the stripper 47 as the upper cutter 41 ascends.

The lifted film stack 33 is moved toward the film separator 70 by the transfer roller 23. The film stack 33 reaching the film separator 70 is rolled around the first delamination guide roll 69 to release the lower cover film 32 and is moved toward the second delamination guide roll. While the film stack is moved to the second delamination guide roll in a direction of an arrow r2, another cover film 32 may be separated from the electrode plate 21. The separated upper and lower cover films 32 are completely separated from the electrode plate 21 by the separation module 71.

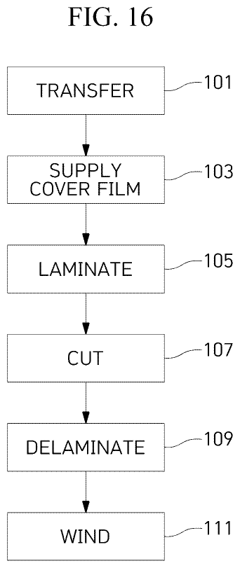

FIG. 16 is a flowchart illustrating a secondary battery manufacturing method according to some embodiments of the present disclosure.

As shown in the drawing, the secondary battery manufacturing method according to the present embodiment may include a transfer operation 101, a cover film supply operation 103, a lamination operation 105, a cutting operation 107, a delamination operation 109, and a winding operation 111.

Transfer operation 101 is a process of moving the electrode plate 21 to be cut along the transfer path through the electrode plate transfer part. In addition, the cover film supply operation 103 is a process of supplying the cover film 32 to be laminated on the surface of the electrode plate 21, i.e., the first surface, the second surface, or the first and second surfaces simultaneously.

The subsequent lamination operation 105 is a process of laminating with the cover film 32 the electrode plate 21 using the herein-described laminating part. The lamination operation 105 may be a process of laminating with the cover film 32 at least one surface of the two surfaces of the electrode plate, i.e., the first surface or the second surface opposite to the first surface, or to both the first and second surfaces.

In addition, the cutting operation 107 is a process of cutting the film stack 33 in a laminated state using the cutting unit 40, and the delamination operation 109 is a process of removing the cover film from the cut film stack 33. In addition, the winding operation 111 is a process of winding the electrode plate 21 from which the cover film 32 is removed.

According to a secondary battery electrode plate cutting device and a secondary battery manufacturing device including the same of the present disclosure which can distribute a load applied on an electrode plate by a cutter so that deformation of a shear surface hardly occurs and deintercalation of an active material from a substrate is not caused.

Although the present disclosure has been described herein with respect to embodiments thereof, the present disclosure is not limited thereto. Various modifications and variations can be made thereto by those skilled in the art within the spirit of the present disclosure as defined by the appended claims and their equivalents.

What is claimed is:

1. A secondary battery electrode plate cutting device comprising:
a cutting unit provided with an upper cutter and a lower cutter installed on opposite sides with an electrode plate, which moves along a transfer path, therebetween and configured to cut the electrode plate;
a cover film supply part configured to supply a cover film to be laminated on a surface of the electrode plate; and
a laminating part configured to laminate the surface of the electrode plate with the cover film before cutting so that the cutting unit cuts the cover film together with the electrode plate.

2. The secondary battery electrode plate cutting device as claimed in claim 1, wherein the laminating part laminates with the cover film one or both of a first surface and a second surface of the electrode plate.

3. The secondary battery electrode plate cutting device as claimed in claim 1, further comprising film pushers configured to elastically support the cover film toward the electrode plate and provided upstream and downstream of the cutting unit.

4. The secondary battery electrode plate cutting device as claimed in claim 3, wherein each of the film pushers comprises a pair of roller assemblies disposed to correspond to one another with the electrode plate therebetween.

5. The secondary battery electrode plate cutting device as claimed in claim 4, wherein the roller assembly comprises:
a casing;
an ascending/descending supporter installed to ascend and descend in the casing;
a spring embedded in the casing and configured to support the ascending/descending supporter; and
a pusher roller installed in the ascending/descending supporter and elastically supported toward the electrode plate by the spring.

6. The secondary battery electrode plate cutting device as claimed in claim 5, further comprising a spacing adjustment part configured to adjust a spacing between the roller assemblies disposed to correspond to one another with the electrode plate interposed therebetween.

7. The secondary battery electrode plate cutting device as claimed in claim 6, wherein the spacing adjustment part comprises:
a side guide fixed to one side of the casing of the roller assembly and extending straightly;
a straight slider mounted on the other side of the casing of the roller assembly and supported on the side guide to be slidable; and
an actuator configured to slidably move the slider.

8. The secondary battery electrode plate cutting device as claimed in claim 4, further comprising a position adjustment part configured to adjust positions of the pair of roller assemblies in an X direction which is a transfer direction of the electrode plate and in a Y direction which is a width direction of the electrode plate while supporting the pair of roller assemblies.

9. The secondary battery electrode plate cutting device as claimed in claim 8, wherein the position adjusting part comprises an X-Y table installed below the roller assembly.

10. A secondary battery manufacturing device comprising:
an electrode plate transfer part configured to transfer an electrode plate along a transfer path;
a cutting unit provided with an upper cutter and a lower cutter installed on opposite sides with the electrode plate therebetween and configured to cut the electrode plate;
a cover film supply part configured to supply a cover film to be laminated on a surface of the electrode plate;
a laminating part configured to laminate with the cover film the electrode plate before cutting so that the cutting unit cuts the cover film together with the electrode plate; and
a film separator configured to separate the cover film from the electrode plate passing through the cutting unit.

11. The secondary battery manufacturing device as claimed in claim 10, wherein the laminating part laminates with the cover film at least one of two surfaces of the electrode plate.

12. The secondary battery manufacturing device as claimed in claim 10, further comprising film pushers configured to elastically support the cover film toward the electrode plate and provided upstream and downstream of the cutting unit.

13. The secondary battery manufacturing device as claimed in claim 12, wherein each of the film pushers comprises a pair of roller assemblies disposed to correspond to one another with the electrode plate therebetween.

14. The secondary battery manufacturing device as claimed in claim 13, wherein the roller assembly comprises:
a casing;
an ascending/descending supporter installed to ascend and descend in the casing;
a spring embedded in the casing and configured to support the ascending/descending supporter; and
a pusher roller installed in the ascending/descending supporter and elastically supported toward the electrode plate by the spring.

15. The secondary battery manufacturing device as claimed in claim 14, further comprising a spacing adjustment part configured to adjust a spacing between the roller assemblies disposed to correspond to one another with the electrode plate interposed therebetween.

16. The secondary battery manufacturing device as claimed in claim 12, further comprising a position adjustment part configured to adjust positions of the pair of roller assemblies in an X direction which is a transfer direction of the electrode plate and in a Y direction which is a width direction of the electrode plate while supporting the pair of roller assemblies.

17. The secondary battery manufacturing device as claimed in claim 16, wherein the position adjusting part comprises an X-Y table installed below the roller assembly.

18. The secondary battery manufacturing device as claimed in claim 10, wherein the film separator comprises:
a delamination guide roll configured to guide and bend the electrode plate on which the cover film is laminated to lift an end portion of the cover film from the electrode plate due to a difference in bendability between the end portion and the electrode plate; and
a separation module configured to enter between the electrode plate and the cover film separated from the electrode plate and perform delamination of the cover film.

19. A secondary battery manufacturing method comprising:
a transfer operation of moving an electrode plate to be cut along a transfer path;
a cover film supply operation of supplying a cover film to be laminated on a surface of the electrode plate;
a lamination operation of laminating with the supplied cover film the electrode plate;
a cutting operation of cutting the electrode plate to which the cover film is laminated;
a delamination operation of removing the cover film from a cut film stack; and
a winding operation of winding the electrode plate from which the cover film is removed.

20. The secondary battery manufacturing method as claimed in claim 19, wherein the lamination operation comprises a process of laminating with the cover film at least one of two surfaces of the electrode plate.
